(19) United States
(12) Patent Application Publication
(10) Pub. No.: US 2017/0032649 A1
(43) Pub. Date: Feb. 2, 2017

(54) Sensor pad for intelligent wireless alarm

(71) Applicant: Zhiguang Hou, Lingyuan City (CN)

(72) Inventor: Zhiguang Hou, Lingyuan City (CN)

(21) Appl. No.: 14/828,789

(22) Filed: Aug. 18, 2015

(30) Foreign Application Priority Data
Jul. 28, 2015 (CN) 201510449159.6

(51) Int. Cl. G08B 21/04; G08B 3/10; H04W 4/00

(52) U.S. Cl. CPC G08B 21/0453; H04W 4/008; G08B 3/10

(57) ABSTRACT

The invention discloses a sensor pad for intelligent wireless alarm, comprising a sensor pad and an alarm device. The sensor pad is provided with contact layers, conductor layers, an elastic isolation layer and a controller; through holes are formed in the elastic isolation layer; the conductor layers are separately arranged on upper and lower sides of the elastic isolation layer; the controller is provided with a non-volatile memory module and Bluetooth module or high-frequency wireless transmitting module; the controller is fixedly connected with conductor layers; the conductor layers, elastic isolation layer and controller are wrapped and fixed by contact layers; the alarm device is provided with a switch, control panel, microphone, loudspeaker and function buttons; and a Bluetooth module or high-frequency wireless receiving module matched with the sensor pad is arranged on the control panel, and the switch, microphone, loudspeaker and function buttons are connected with the control panel.

### FIELD OF THE INVENTION

The invention relates to the field of auxiliary devices for medical care and particularly relates to a sensor pad for intelligent wireless alarm.

### BACKGROUND OF THE INVENTION

An sensor pad is a common auxiliary device for medical care and can be used on a hospital bed, a wheelchair or a closestool. By placing the sensor pad in an appropriate position on the hospital bed, the wheelchair or the closestool, the sensor pad plays a function by perceiving a change in external pressure and timely notify a nursing person of checking and taking care of a patient through an alarm device connected therewith. When the patient leaves the hospital bed, the wheelchair or the closestool, the alarm device connected with the sensor pad can emit an alarm, but such a sensor pad has the following problems during use: 1) the using time of the sensor pad cannot be recorded in detail, and the using condition of the sensor pad cannot be judged according to records. Namely, whether the sensor pad is in a normal using state and using period cannot be known, aging or abrasion of a circuit can be caused if the sensor pad exceeds the using period, and when the patient leaves the sensor pad, an alarm system possibly cannot emit an alarm, the nursing person cannot monitor the specific condition of the patient after alarm malfunction, and the treatment timing may be missed. 2) At present, the sensor pad is connected with the alarm device through an electric wire, and due to such connection between the sensor pad and the alarm device through a conducting wire, as the electric wire is likely to be wound, disconnected by external force or a shorted, timely emitting of an alarm by the alarm device is affected.

### SUMMARY OF THE INVENTION

In order to solve the problems in the prior art, the invention provides a sensor pad for intelligent wireless alarm.

In order to achieve the above object, the technical solution adopted by the invention is as follows: a sensor pad for intelligent wireless alarm comprises a sensor pad and an alarm device, wherein the sensor pad comprises contact layers, conductor layers, an elastic isolation layer and a controller; circular through holes are uniformly distributed in the elastic isolation layer; the conductor layers are separately arranged on the upper side and the lower side of the elastic isolation layer; the controller is provided with a non-volatile memory module and a Bluetooth module or a high-frequency wireless transmitting module; the controller is fixedly connected with the conductor layers; the conductor layers, the elastic isolation layer and the controller are wrapped and fixed by the contact layers; the alarm device comprises a switch, a control panel, a loudspeaker and function buttons; a Bluetooth module or a high-frequency wireless receiving module which is mutually matched with the sensor pad is arranged on the control panel, and the control panel is arranged within the alarm device; the switch and the function buttons are respectively arranged on the two sides of the alarm device; the loudspeaker is arranged on the front surface of the alarm device; and the switch, the loudspeaker and the function buttons are respectively connected with the control panel.

After the technical solution of the invention is adopted, when a patient sits or lies on the sensor pad, as the sensor pad can be deformed by pressure under the action of the pressure of a body of the patient, the upper and lower conductor layers can squeeze the elastic isolation layer to cause deformation thereof, and as the innumerable circular through holes are formed in the elastic isolation layer, conductive material layers on the conductor layers come into contact with each other under the action of the pressure to constitute a current path, at this time, the high-frequency wireless transmitting module or the Bluetooth module in the sensor pad is in an off state and does not emit signals. As the alarm device does not receive signals transmitted by the sensor pad, at this time, the alarm device is in a normal using state and cannot emit an alarm. When the patient leaves the sensor pad, the high-frequency wireless transmitting module or the Bluetooth module in the sensor pad emits signals, then the high-frequency wireless receiving module or the Bluetooth module in the alarm device can receive the signals from the sensor pad, and at this time the alarm device emits an alarm to timely reminding the nursing person. By using a wireless connection way, the winding of a conducting wire/the disconnection thereof under the action of external force/a short circuit thereof and other potential safety troubles are fundamentally avoided. By using the wireless connection way, the sensor pad and the alarm device can be used in a very large region, so that the flexibility and the convenience are greatly improved.

As a further improvement, the elastic isolation layer is an insulation sponge. By adopting the insulation sponge as the elastic isolation layer, the following advantages are realized: 1) after the sponge is in contact with a human body, the experience of a user is better. 2) The manufacturing cost is saved.

As a further improvement, the conductor layers are PET thin film circuit boards, and conductive silver pieces or carbon pieces or graphene pieces are arranged on the outer surfaces of the PET thin film circuit boards. By mutually combining the thin film circuit boards with such conductive materials as the conductive silver pieces or the carbon pieces or the graphene pieces, the conducting wire effect of the conductive layers is more excellent.

As a further improvement, two groups of metal connection pieces which correspond to each other are further arranged in the sensor pad; one group of metal connection pieces are connected with the conductor layer above the elastic isolation layer, and the other group of metal connecting pieces are connected with the conductor layer below the elastic isolation layer; and wherein one group of metal connection pieces is arranged between the controller and the conductor layer. As metal has a good conductive effect, by arranging the metal connection pieces here, the conductor layers above and below the elastic isolation layer can realize conduction with good movements; and meanwhile, the other group of the metal connection pieces is connected with the controller, and similarly, the controller and the conductor layer can realize the conductive effect with the sufficient movements.

As a further improvement, a sound recording module is further arranged on the control panel of the alarm device, a microphone is arranged on the front surface of the alarm device, and the microphone is connected with the sound recording module. By arranging the sound recording module, alarm sound can be customized in a personalized manner. Different psychological demands of the patients are met.

As a further improvement, an extension interface is further arranged on the surface of the alarm device, and the extension interface is connected with the control panel. Through the extension interface, the alarm device can be connected with a nurse station through a wired circuit, so that medical staff can better provide high-quality services for the patient at the first time.

As a further improvement, a buckle capable of fixing the alarm device is arranged on the back of the alarm device. Through the buckle on the back of the alarm device, when the patient moves within a small range, the alarm device can be clamped in a fixed position to prevent loss or damage.

### BRIEF DESCRIPTION OF THE DRAWINGS

FIG. 1 is a perspective schematic diagram of a sensor pad for intelligent wireless alarm;

FIG. 2 is a perspective schematic diagram of the front surface of an alarm device of the sensor pad for intelligent wireless alarm;

FIG. 3 is a perspective schematic diagram of the back surface of the alarm device of the sensor pad for intelligent wireless alarm;

FIG. 4 is an exploded schematic diagram of the sensor pad for intelligent wireless alarm;

FIG. 5 is a circuit principle diagram of an extension interface of the alarm device;

FIG. 6 is a circuit diagram of a high-frequency wireless transmitting module in the inductor of embodiment 2;

FIG. 7 is a circuit diagram of a high-frequency wireless receiving module in the inductor of embodiment 2; and

Reference signs: 1: sensor pad; 2: alarm device; 11: contact layer; 12: conductor layer; 13: elastic isolation layer; 14: controller; 15: metal connection piece; 21: switch; 22: control panel; 23: loudspeaker; 24: function button; 25: microphone; 26: extension interface; and 27: buckle.

### DETAILED DESCRIPTION OF THE EMBODIMENTS

The preferred implementations of the invention will be further described below in conjunction with the accompanying drawings.

### Embodiment 1

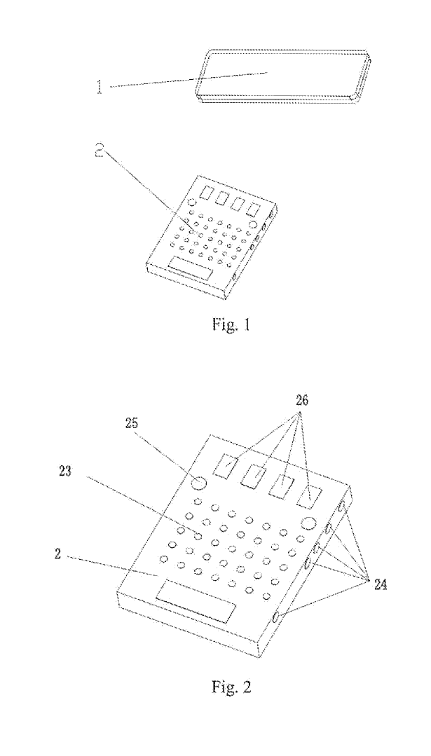

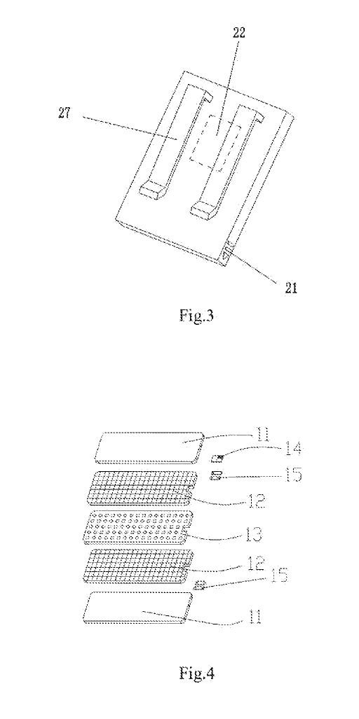

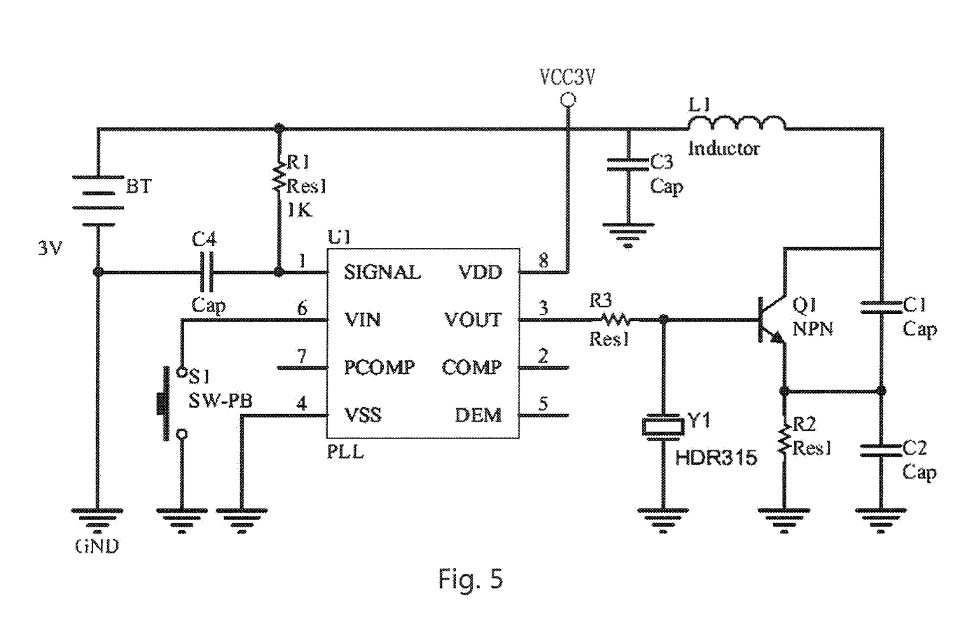

As shown in FIGS. 1-5, a sensor pad for intelligent wireless alarm comprises a sensor pad and an alarm device; the sensor pad comprises contact layers, conductor layers, an elastic isolation layer and a controller; the elastic isolation layer is an insulation sponge, and circular through holes are uniformly distributed in the insulation sponge. The conductor layers are PET thin film circuit boards, and conductive silver pieces or carbon pieces or graphene pieces are arranged on the outer surfaces of the PET thin film circuit boards. The conductor layers are separately arranged on the upper side and the lower side of the elastic isolation layer; the controller is provided with a non-volatile memory module and a Bluetooth module; the controller is fixedly connected with the upper conductor layer; the conductor layers, the elastic isolation layer and the controller are wrapped and fixed by the contact layer; and in order to better increase the conductive effect, two groups of metal connection pieces are respectively arranged on the upper and lower conductor layers, wherein the upper metal connection pieces are arranged between the controller and the conductor layer. The alarm device comprises a switch, a control panel, a microphone, a loudspeaker and function buttons; and the control panel is arranged within the alarm device, and a Bluetooth module and a sound recording module which are mutually matched with the sensor pad are arranged on the control panel, and the microphone is connected with the sound recording module. The switch and the function buttons are separately arranged on the two sides of the alarm device; the microphone, the loudspeaker and an extension interface are arranged on the front surface of the alarm device; and a buckle capable of fixing the alarm device is arranged on the back of the alarm device. The switch, the microphone, the loudspeaker, the function buttons and the extension interface are respectively connected with the control panel.

### Embodiment 2

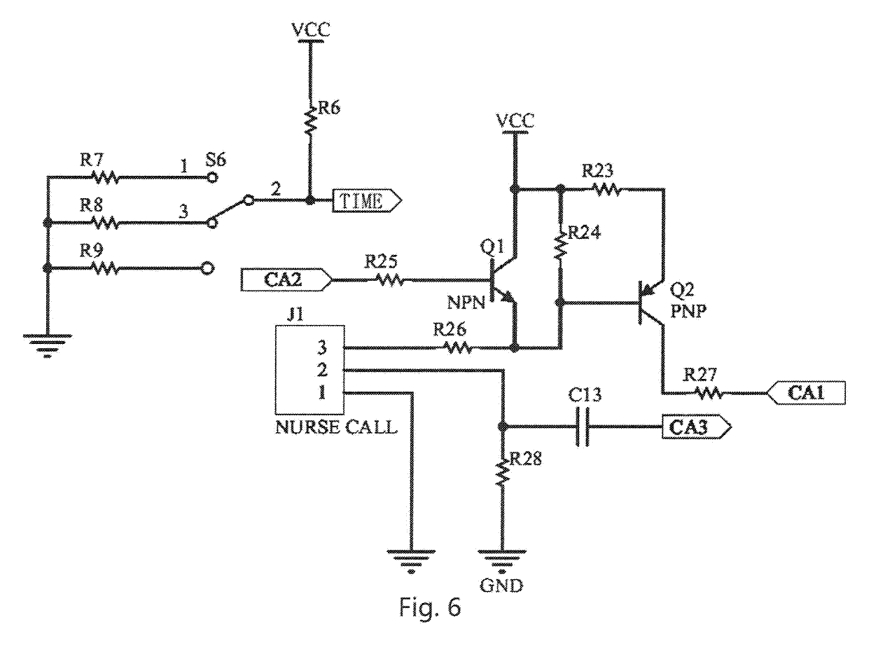

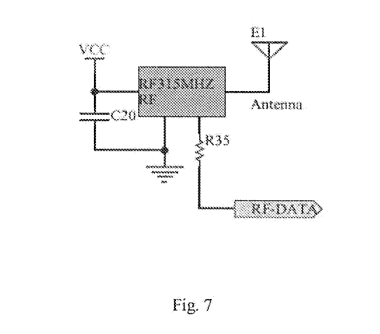

As shown in FIGS. 1-7, a sensor pad for intelligent wireless alarm comprises a sensor pad and an alarm device; the sensor pad comprises contact layers, conductor layers, an elastic isolation layer and a controller; the elastic isolation layer is an insulation sponge, and circular through holes are uniformly distributed in the insulation sponge. The conductor layers are PET thin film circuit boards, and conductive silver pieces or carbon pieces or graphene pieces are arranged on the outer surfaces of the PET thin film circuit boards. The conductor layers are separately arranged on the upper side and the lower side of the elastic isolation layer; the controller is provided with a non-volatile memory module and a high-frequency wireless transmitting module; the controller is fixedly connected with the upper conductor layer; the conductor layers, the elastic isolation layer and the controller are wrapped and fixed by the contact layer; and in order to better increase the conductive effect, and two groups of metal connection pieces are respectively arranged on the upper and lower conductor layers, wherein the upper metal connection pieces are arranged between the controller and the conductor layer. The alarm device comprises a switch, a control panel, a microphone, a loudspeaker and function buttons; and the control panel is arranged within the alarm device, and a high-frequency wireless receiving module and a sound recording module which are mutually matched with the sensor pad are arranged on the control panel, and the microphone is connected with the sound recording module. The switch and the function buttons are separately arranged on the two sides of the alarm device; the microphone, the loudspeaker and an extension interface are arranged on the front surface of the alarm device; and a buckle capable of fixing the alarm device is arranged on the back of the alarm device. The switch, the microphone, the loudspeaker, the function buttons and the extension interface are respectively connected with the control panel.

The pairing method of the alarm device and the sensor pad is as follows: the function buttons in the alarm device comprise the following buttons: a MODE button for switching between a sound mode and a soundless mode; a TONE button for regulating the tone of the alarm; a VOLUME button for regulating the volume of the alarm; and an RF button for code-matched pairing of the alarm device and the sensor pad. When the alarm device and the sensor pad are connected for debugging, the RF button is pressed long for 3 S, an RF lamp flashes slowly, the sensor pad is triggered once, at this time, the RF lamp on the alarm device flashes fast for several times and then is turned off, and when the RF button is re-triggered, the alarm device gives a prompt of an alarm state, and then the code matching is successful. When the connection way of the alarm device and the sensor pad needs to be cleared, the RF button of the alarm device is pressed long for 5 S, then the RF lamp of the alarm device flashes fast for several times and then is turned off, and then unpairing between the alarm device and the sensor pad is successful.

It can be understood that the above specific description of the invention is only used for describing the invention rather than limiting the invention to the technical solutions described in the embodiments of the invention. Those of ordinary skill in the art should understand that modifications or equivalent substitutions can be still made to the invention to achieve the same technical effects; and as long as the using needs are met, the modifications or the equivalent substitutions are within the scope of protection of the invention.

1. A sensor pad for intelligent wireless alarm, comprising a sensor pad (1) and an alarm device (2); characterized in that:
the sensor pad (1) comprises contact layers (11), conductor layers (12), an elastic isolation layer (13) and a controller (14); circular through holes are uniformly distributed in the elastic isolation layer (13); the conductor layers (12) are separately arranged on the upper side and the lower side of the elastic isolation layer (13); the controller (14) is provided with a non-volatile memory module and a Bluetooth module or a high-frequency wireless transmitting module; the controller (14) is fixedly connected with the conductor layers (12); the conductor layers (12), the elastic isolation layer (13) and the controller (14) are wrapped and fixed by the contact layers (11);
the alarm device (2) comprises a switch (21), a control panel (22), a loudspeaker (23) and function buttons (24); a Bluetooth module or a high-frequency wireless receiving module which is mutually matched with the sensor pad is arranged on the control panel (22), and the control panel (22) is arranged within the alarm device; the switch (21) and the function buttons (24) are separately arranged on the two sides of the alarm device; the loudspeaker (23) is arranged on the front surface of the alarm device; and the switch (21), the loudspeaker (24) and the function buttons (23) are respectively connected with the control panel (22).

2. The sensor pad for intelligent wireless alarm according to claim 1, characterized in that the elastic isolation layer (13) is an insulation sponge.

3. The sensor pad for intelligent wireless alarm according to claim 1, characterized in that the conductor layers (12) are PET thin film circuit boards, and conductive silver pieces or carbon pieces or graphene pieces are arranged on the outer surfaces of the PET thin film circuit boards.

4. The sensor pad for intelligent wireless alarm according to claim 1, characterized in that two groups of metal connection pieces (15) which correspond to each other are further arranged in the sensor pad; one group of metal connection pieces are connected with the conductor layer (12) above the elastic isolation layer (13), and the other group of metal connecting pieces are connected with the conductor layer (12) below the elastic isolation layer (13); wherein one of the groups of metal connection pieces (15) is arranged between the controller (14) and the conductor layer (12).

5. The sensor pad for intelligent wireless alarm according to claim 1, characterized in that a sound recording module is further arranged on the control panel of the alarm device (2), a microphone (25) is arranged on the front surface of the alarm device, and the microphone (25) is connected with the sound recording module.

6. The sensor pad for intelligent wireless alarm according to claim 1, characterized in that an extension interface (26) is further arranged on the surface of the alarm device, and the extension interface (26) is connected with the control panel.

7. The sensor pad for intelligent wireless alarm according to any of claims 1-6, characterized in that a buckle (27) capable of fixing the alarm device is arranged on the back of the alarm device.
